(19) United States
(12) Patent Application Publication
(10) Pub. No.: US 2023/0124765 A1
(43) Pub. Date: Apr. 20, 2023

(54) MACHINE LEARNING-BASED DIALOGUE AUTHORING ENVIRONMENT

(71) Applicant: Microsoft Technology Licensing, LLC, Redmond, WA (US)

(72) Inventors: Gabriel A. DESGARENNES, Issaquaah, WA (US); William B. DOLAN, Kirkland, WA (US); Christopher John BROCKETT, Kirkland, WA (US); Hamid PALANGI, Bellevue, WA (US); Ryan VOLUM, Seattle, WA (US); Olivia Diane DENG, San Ramon, CA (US); Eui Chul SHIN, San Francisco, CA (US); Randolph Lawrence D'AMORE, Renton, WA (US); Sudha RAO, Bothell, WA (US); Yun Hui XU, Phoenix, AZ (US); Benjamin David VAN DURME, Baltimore, MD (US); Kellie Nicole HILL, Auburn, WA (US)

(73) Assignee: Microsoft Technology Licensing, LLC, Redmond, WA (US)

(21) Appl. No.: 17/961,189

(22) Filed: Oct. 6, 2022

Related U.S. Application Data
(60) Provisional application No. 63/255,796, filed on Oct. 14, 2021.
(60) Provisional application No. 63/345,216, filed on May 24, 2022.

(51) Int. Cl. G06N 20/00; G06F 40/20; G06F 40/30; G06F 16/332; G06F 16/31

(52) U.S. Cl. CPC G06N 20/00; G06F 40/20; G06F 40/30; G06F 16/3329; G06F 16/322

(57) ABSTRACT

Aspects of the present disclosure relate to a machine learning-based dialogue authoring environment. In examples, a developer or creator of a virtual environment may use a generative multimodal machine learning (ML) model to create or otherwise update aspects of a dialogue tree for one or more computer-controlled agents and/or players of the virtual environment. For example, the developer may provide an indication of context associated with the dialogue for use by the ML model, such that the ML model may generate a set of candidate interactions accordingly. The developer may select a subset of the candidate interactions for inclusion in the dialogue tree, which may then be used to generate associated nodes within the tree accordingly. Thus, nodes in the dialogue tree may be iteratively defined based on model output of the ML model, thereby assisting the developer with dialogue authoring for the virtual environment.

### CROSS-REFERENCE TO RELATED APPLICATIONS

This application claims priority to U.S. Provisional Application No. 63/345,216, filed May 24, 2022, titled “Creation and Personalization of Virtual Gamers” and U.S. Provisional Application No. 63/255,796, filed Oct. 14, 2021, titled “Grounded Multimodal Agent Interactions” the entire disclosures of which are hereby incorporated herein by reference.

### BACKGROUND

Traditionally, manually authoring dialogue for non-player characters (NPCs) of a virtual environment has been a time-consuming, potentially tedious, and expensive process. Further, the amount of effort associated with NPC dialogue may serve as a limiting factor to the amount, depth, and/or variability of NPC storylines that are included in the virtual environment, thus resulting in a user experience that is unnecessarily limited.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to a machine learning-based dialogue authoring environment. In examples, a developer or creator of a virtual environment may use a generative multimodal machine learning (ML) model to create or otherwise update aspects of a dialogue tree for one or more computer-controlled agents and/or players of the virtual environment. For example, the developer may provide an indication of context associated with the dialogue for use by the ML model, such that the ML model may generate a set of candidate interactions accordingly. The developer may select a subset of the candidate interactions for inclusion in the dialogue tree, which may then be used to generate associated nodes within the tree accordingly. Thus, nodes in the dialogue tree may be iteratively defined based on model output of the ML model, thereby assisting the developer with dialogue authoring for the virtual environment.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system in which a machine learning-based dialogue authoring environment may be used according to aspects of the present disclosure.

FIG. 2 illustrates an overview of an example conceptual diagram for generating machine learning-based dialogue according to aspects described herein.

FIG. 3 illustrates an overview of an example method for generating dialogue for a virtual environment using a machine learning-based dialogue authoring environment according to aspects described herein.

FIG. 4 illustrates an overview of an example method for managing interactions between an agent and a user within a virtual environment based on machine learning-based dialogue according to aspects described herein.

FIG. 5 illustrates an overview of an example method for managing an agent for a virtual environment at a cloud service according to aspects described herein.

FIGS. 6A-6C illustrate overviews of an example user interface with which dialogue may be authored according to aspects described herein.

FIG. 7 is a block diagram illustrating example physical components of a computing device with which aspects of the disclosure may be practiced.

FIG. 8 is a simplified block diagram of a mobile computing device with which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a computer-controlled agent (e.g., a non-player character or bot) may exist within a virtual environment, such that a user may interact with the computer-controlled agent. For example, the user may encounter the agent as a non-player character (NPC) in a video game, such that the user may correspond with or otherwise interact with the NPC. The NPC may advance a plot of the video game and/or may affect a certain outcome within the virtual environment (e.g., an exchange of one or more items or a branch in a storyline), among other examples. However, such agent interactions are typically manually created by a video game developer or other content creator, resulting in increased development costs, frustration from tedious and potentially repetitive manual operations, lack of variety across NPCs, and/or the potential for human error, among other detriments.

Accordingly, aspects of the present disclosure relate to a machine learning-based authoring environment. The authoring environment is capable of generating dialogue, images, visuals, virtual objects, executable code, or other types of content and objects based upon the type of application or platform that utilizes the authoring environment. In examples, a developer or creator of a virtual environment may use a generative multimodal machine learning (ML) model to create or otherwise update aspects of a dialogue tree associated with the virtual environment. For example, the developer may provide an indication of context associated with the dialogue for use by the ML model, such that the ML model may then generate a set of candidate interactions for the computer-controlled agent accordingly. The developer may select a subset of the candidate interactions (e.g., including all or some of the candidate interactions), which may then be used to generate associated nodes within the dialogue tree accordingly. A resulting node in the dialogue tree may then be further processed to similarly generate an associated set of candidate interactions from which the developer may select and ultimately add nodes to the dialogue tree. Processing for a child node in the dialogue tree may incorporate past interactions (e.g., as defined by one or more parent nodes in the dialogue tree) as grounding with which to generate a set of candidate interactions. Thus, aspects described herein may enable a developer to iteratively define nodes within a dialogue tree using model output from a generative multimodal ML model, thereby reducing the cost, time, and/or complexity associated with defining dialogue for computer-controlled agents associated with a virtual environment. In further examples, the generative multimodal ML model is operable to generate virtual objects in the virtual environment, computer executable code capable of generating, modifying, or controlling object or characters in the virtual environment, or the like. That is, the generative multimodal model may also function as a code generation model which generates executable code or programmatic content for the virtual environment or associated application. In examples, the authoring environment may include multiple machine learning models, e.g., a generative model, a code generation model, a text generation model, a conversational model, a virtual object generation model, or the like. Alternatively, or additionally, the authoring environment may include a foundational model.

It will be appreciated that aspects of the present disclosure may be used to generate dialogue for any number of parties, including but not limited to, a single computer-controlled agent (e.g., as a monologue, an outburst, or as a diary entry), two computer-controlled agents (e.g., thereby enabling a user to observe the dialogue between the computer-controlled agents), a computer-controlled agent and a user (e.g., such that the user may select from a pre-defined set of interactions, as may have been generated according to aspects of the present disclosure), or two or more computer-controlled agents and/or users, among other examples. Further, while aspects are described herein with respect to a “developer” of a virtual environment (which may be used to generate a dialogue or other interaction that is experienced by a “player”), it will be appreciated that such aspects need not be limited to a specific class of users. Similarly, a “user” may refer to a developer, a creator, or a player, among other examples. Further, while for clarity of explanation aspects of the present disclosure have been described with respect to a video game or other virtual environment, aspects disclosed herein may be practiced with other types of applications and in other environments, such as educational applications, productivity applications, online or web-based applications, or the like. For example, aspects of the present application can be used to generate actions or dialog for instructional agents in an educational application or on an educational platform, helper agents that are part of an enterprise application or platform, customer service agents on a website or mobile application, etc. One of skill in the art will appreciate that a computer-controlled agent, as used herein, may refer to a non-player character in a video game, a digital assistant on a mobile device or that is part of a website or mobile application, a digital customer service agent, a digital educational assistant that is part of an educational application or educational platform, a digital productivity assistant that is part of an enterprise platform, enterprise application, or content creation application, or the like. That is, aspects of the present disclosure are not limited to being employed in a video game or virtual environment, rather, the aspects disclosed herein can be practiced with other types of applications without departing from the scope of this disclosure.

Multimodal output generated by an ML model according to aspects of the present disclosure may comprise natural language output and/or programmatic output, among other examples. A generative multimodal ML model (also generally referred to herein as a multimodal ML model) used according to aspects described herein may be a generative transformer model, in some examples. Example ML models include, but are not limited to, the BigScience Large Open-science Open-access Multilingual Language Model (BLOOM), DALL-E, DALL-E 2, or Jukebox. In some instances, explicit and/or implicit feedback may be processed to improve the performance of multimodal ML model. In examples, the ML model may be a general model that is used to generate model output for any of a variety of contexts (e.g., multiple virtual environments and/or multiple computer-controlled agents). As another example, the ML model may be finetuned for a specific context, for example based on background information and/or historical user interactions associated with a given set of virtual environments and/or computer-controlled agents, among other examples. Similarly, a model may be finetuned based on candidate interactions that are selected, are not selected, are revised, and/or are added (e.g., by a developer) during the dialogue authoring process, among other examples. In examples, an explicit negative indication may be provided by the developer for a candidate interaction that is not relevant or that is nonsensical, among other examples.

In examples, user input and/or model output to a generative multimodal ML model is multimodal, which, as used herein, may comprise one or more types of content. Example content includes, but is not limited to, spoken or written language (which may also be referred to herein as “natural language output”), code (which may also be referred to herein as “programmatic output”), images, video, audio, gestures, visual features, intonation, contour features, poses, styles, fonts, and/or transitions, among other examples. Thus, as compared to a machine learning model that processes natural language input and generates natural language output, aspects of the present disclosure may process input and generate output having any of a variety of content types.

Multimodal output of a generative multimodal ML model may be processed and used to generate a dialogue tree for one or more computer-controlled agents according to aspects described herein. As used herein, a dialogue tree may include one or more nodes that represent a set of interactions (e.g., for a computer-controlled agent or between one or more computer-controlled agents and/or players). For example, a dialogue tree may represent an interaction between a computer-controlled agent and a player, where each node of the dialogue tree indicates a dialogue turn for either the computer-controlled agent or the player. It will be appreciated that dialogue turns need not be alternating. In an example, a computer-controlled agent may express a dialogue turn associated with a dialogue tree node, such that a set of potential responses (e.g., associated with a set of child nodes for the dialogue tree node) are presented for selection to a player. The player may then select a node from the set of child nodes, thereby causing the associated dialogue turn to be expressed, at which point a subsequent computer-controlled agent dialogue turn may be expressed based on a child node associated therewith.

Accordingly, each node of a dialogue tree may have associated natural language output (e.g., which may be textual and/or auditory), programmatic output (e.g., as may be executed to affect the virtual environment in association with the natural language output), an indication of a mood associated with the natural language output, and/or an indication of an associated animation, among any of a variety of other types of model output. In some instances, such aspects associated with a node of a dialogue tree may not be generated by the ML model and may instead be generated using any of a variety of other techniques (e.g., sentiment classification or another ML model), such that dialogue of a node is supplemented accordingly. Similarly, a node of a dialogue tree may include user input, as may be received to edit or replace suggested dialogue that was generated by the ML model.

To create a computer-controlled agent with which a player can interact according to aspects described herein, a developer may provide agent information that is used to generate a set of candidate interactions. In examples, the agent information may include one or more agent attributes, including, but not limited to, one or more agent traits, an agent persona, one or more agent goals, and/or an agent mood. As another example, agent information may also include background information associated with the virtual environment (e.g., “lore” for a video game application, virtual environment context, and/or API documentation, among other information sources). Agent information may additionally, or alternatively, include historical information associated with a player (e.g., past interactions between the player and the computer-controlled agent or past decisions made by the player). As another example, virtual environment state information may be used, which may indicate a state of a player inventory, characteristics of a player (e.g., a health level and/or an experience level), aspects of the virtual environment that have changed as a result of user interaction(s) (e.g., changes to available environmental resources or interactions with other computer-controlled agents), and/or one or more player preferences. Certain aspects of such agent information (and, similarly, information associated with a dialogue tree node, such as natural language output) may act as a placeholder, which may be populated according to player-specific, device-specific, and/or virtual environment-specific information when managing interactions by a computer-controlled agent according to aspects described herein.

The agent information may be obtained from a developer as one or more prompts, a user selection from a dropdown menu (e.g., relating to a mood or persona for the computer-controlled agent), or based on any of a variety of other user input. Agent information may be provided for any number of parties that are involved in an interaction (e.g., a single computer-controlled agent or a computer-controlled agent and a player). The agent information may be processed using a generative multimodal ML model as described above, thereby generating model output. In examples, the ML model generates multiple instances of model output, each indicative of a candidate interaction. The candidate interactions may be presented for selection by the developer, such that a node is generated in a dialogue tree in response to the user selection of one or more candidate interactions. The dialogue tree may thus be populated with nodes as a result of multiple generative iterations according to aspects described herein. In examples, the developer may change agent information during the generation process, as may be the case when the mood and/or objective of a computer-controlled agent is to change during an interaction.

While aspects of the present disclosure are described in examples where a dialogue tree for a computer-controlled agent is defined for a video game or other virtual environment, it will be appreciated that the described aspects are applicable in any of a variety of other content and/or domains. For instance, a journal of a computer-controlled agent may be generated using similar techniques, as may descriptive text for items, objects, or other entities of a virtual environment. Further, while for clarity of explanation aspects of the present disclosure have been described with respect to a video game or other virtual environment, aspects disclosed herein may be practiced with other types of applications and in other environments, such as educational applications, productivity applications, online or web-based applications, or the like. For example, aspects of the present application can be used to generate actions or dialog for instructional agents in an educational application or on an educational platform, helper agents that are part of an enterprise application or platform, customer service agents on a website or mobile application, etc. One of skill in the art will appreciate that a computer-controlled agent, as used herein, may refer to a non-player character in a video game, a digital assistant on a mobile device or that is part of a website or mobile application, a digital customer service agent, a digital educational assistant that is part of an educational application or educational platform, a digital productivity assistant that is part of an enterprise platform, enterprise application, or content creation application, or the like. That is, aspects of the present disclosure are not limited to being employed in a video game or virtual environment, rather, the aspects disclosed herein can be practiced with other types of applications without departing from the scope of this disclosure.

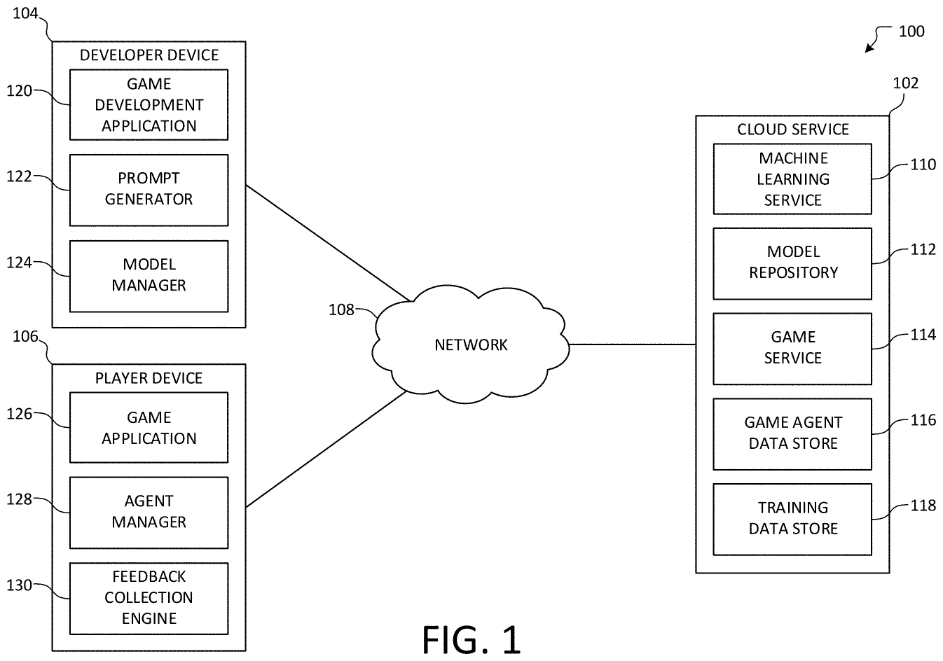

FIG. 1 illustrates an overview of an example system 100 in which a machine learning-based dialogue authoring environment may be used according to aspects of the present disclosure. As illustrated, system 100 includes cloud service 102, developer device 104, player device 106, and network 108. In examples, cloud service 102, developer device 104, and/or player device 106 may communicate via network 108, which may comprise a local area network, a wireless network, or the Internet, or any combination thereof, among other examples.

Player device 106 includes game application 126, agent manager 128, and feedback collection engine 130. Player device 106 may be a console gaming system, a mobile device, a smartphone, a personal computer, or any other type of device capable of executing a game locally or accessing a hosted game on a server. Game application 126 may communicate with cloud service 102, which hosts game service 114 (or other type of application associated with a virtual environment). In one example, a game associated with the game service 114 may be hosted directly by the cloud service 102. It will be appreciated that any of a variety of other virtual environments may be used in other examples.

Player device 106 further includes agent manager 128, which may manage the behavior of one or more computer-controlled agents associated with game application 126 based on an associated dialogue tree (e.g., as may be stored by game agent data store 116). In examples, agent manager 128 provides an indication of model output from a dialogue tree node to game application 126 for further processing (e.g., to affect the behavior of a computer-controlled agent associated therewith). As another example, agent manager 128 processes at least a part of the model output to affect the behavior of a computer-controlled agent. In some examples, agent manager 128 may process or otherwise supplement one or more placeholders of model output, for example to include player-specific, device-specific, and/or virtual environment-specific information into an interaction accordingly.

Feedback collection engine 130 may generate or otherwise obtain implicit and/or explicit feedback (e.g., based on telemetry data or user input). The feedback collected can include information related to the user's playstyle, user communication, user interaction with the game, user interaction with other players, user interaction with other agents, outcomes associated with actions performed by one or more computer-controlled agents in-game, interactions between the player and the computer-controlled agent(s), actions in-game, or any type of information generated by player device 106 as a user plays a game or interacts with any of a variety of other virtual environments. In order to comply with user privacy considerations, information may only be collected by feedback collection engine 130 upon receiving permission from the user to do so. The user may opt in or out of said collection at any time. The data collected may be implicit data, e.g., data based upon the user's normal interactions with the game, or explicit data, such as specific commands provided by the user to the system. In examples, feedback collection engine 130 may provide an indication of the obtained feedback to cloud service 102, such that the feedback may be stored in training data store 118 and/or used to train or update an ML model accordingly.

Developer device 104 is illustrated as comprising game development application 120, prompt generator 122, and model manager 124. Aspects of developer device 104 may be similar to player device 106 and are therefore not necessarily redescribed below in detail. It will be appreciated that, in some examples, aspects described herein with respect to developer device 104 may be performed by player device 106, as may be the case when a player also acts as a developer (e.g., to define and/or update aspects of a virtual environment), among other examples.

Game development application 120 is used to define and/or change various aspects of a virtual environment (e.g., as may be associated with game service 114 and game application 126). As an example, game development application 120 may be a development environment for a game engine, though it will be appreciated that any of a variety of software may be used to define/change aspects of a virtual environment. Similarly, game development application 120 need not be a single application but may instead be a suite of applications in other examples.

A developer may use game development application 120 to define and/or change a dialogue tree associated with one or more players and/or computer-controlled agents of the virtual environment accordingly. For example, the developer may provide agent information (e.g., indicating a context for which the dialogue tree is being generated), such that a set of candidate interactions may be generated and presented to the developer. The developer may then use game development application 120 to select one or more interactions from the set of candidate interactions, such that subsequent (e.g., child) nodes may thus be iteratively generated for the dialogue tree. The resulting dialogue tree may be stored for later use (e.g., as a player is exploring a virtual environment), for example in game agent data store 116 of cloud service 102.

In examples, prompt generator 122 may be used to generate at least a part of the agent information that is used to create a dialogue tree for a computer-controlled agent according to aspects described herein. Prompt generator 122 may receive user input (e.g., indicating at least a part of a prompt) and/or may process implicit/explicit user feedback (e.g., as may be associated with a user of developer device 104 and/or player device 106) to generate prompts accordingly. In some instances, prompt generator 122 may start with a template or other preexisting agent information, as may be associated with an existing computer-controlled agent or obtained from model repository 112. Thus, prompt generator 122 is operable to generate new prompts or instructions based upon the collected feedback or alter existing prompts based upon newly collected feedback, among other examples. It will be appreciated that agent information may be generated using any of a variety of other techniques, for example based solely on manual input (e.g., from a user of developer device 104 and/or player device 106), by one or more machine learning models, or via a combination of various different techniques disclosed herein.

Model manager 124 may process agent information (e.g., as may be obtained by game development application 120 and/or generated by prompt generator 122) to generate model output comprising a set of candidate interactions according to aspects described herein. For example, model manager 124 may provide an indication of the agent information to machine learning service 110 of cloud service 102 to obtain model output from machine learning service 110 in response. In examples, model manager 124 requests candidate interactions having varying associated tones, moods, and/or goals, as may be achieved by altering the provided agent information. For example, model manager 124 may obtain a set of candidate interactions having a positive candidate interaction, a negative candidate interaction, an angry candidate interaction, and/or a curious candidate interaction, among other examples. As another example, model manager 124 may request a number of highly ranked instances of model output (e.g., the three or five most probable model outputs), such that the highly ranked instances are provided as the set of candidate interactions. As noted above, the model output may include natural language and/or programmatic output. An indication of the model output that was obtained by model manager 124 may be provided to game development application 120, such that a developer may select one of or more of the candidate interactions as discussed above.

Cloud service 102 is illustrated as including machine learning service 110, model repository 112, game service 114, game agent data store 116, and training data store 118. In examples, machine learning service 110 receives a request from developer device 104 (e.g., from model manager 124) to generate model output as discussed above. For example, the request may include an indication of agent information for a given computer-controlled agent. In some instances, the request includes an indication of a model stored by model repository 112 and/or agent information stored by game agent data store 116. Thus, at least a part of the agent information processed by machine learning service 110 may be local to cloud service 102 in some examples. As another example, at least a part of the agent information may be obtained from another data source (not pictured).

Machine learning service 110 may use any number of different models (e.g., individually or in combination). For example, model repository 112 may include foundation models, language models, speech models, video models, and/or audio models may be employed. As used herein, a foundation model is a model trained on broad data that can be adapted to a wide range of tasks (e.g., models capable of processing various different tasks or modalities). In examples, AB testing and/or reinforcement learning may be used to finetune model output for a given virtual environment and/or set of users, among other examples. In examples, a multimodal machine learning model of model repository 112 may have been trained using training data having a plurality of content types. Thus, given content of a first type, machine learning service 110 may generate content having any of a variety of associated types. It will be appreciated that model repository 112 may include foundation model as well as models that have been finetuned (e.g., for a specific virtual environment, a specific user or set of users, or a specific type of virtual environment).

Training data store 118 may store training data associated with machine learning service 110. As noted above, training data store 118 may store training data based on feedback generated or otherwise obtained by feedback collection engine 130 and/or from developer device 104 (e.g., as may be generated as a result of candidate selections by a user thereof), such that model performance (e.g., of models in model repository 112) may be improved over time.

Cloud service 102 further includes game service 114, which may communicate with game application 126 and/or game development application 120. In examples, game service 114 may be used to coordinate multiple instances of a virtual environment, as may be the case when the virtual environment is a multiplayer game. As another example, game service 114 may render at least a part of the virtual environment, which may be provided to developer device 104 and/or player device 106 for display to an associated user.

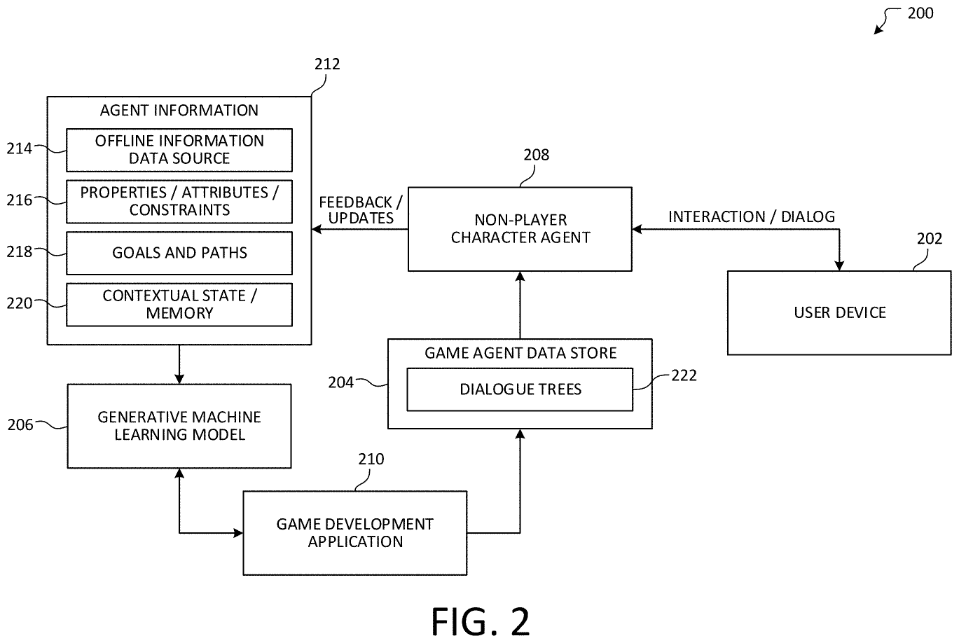

Game agent data store 116 of cloud service 102 may store information associated with a given virtual environment (e.g., the virtual environment associated with game service 114, game development application 120, and game application 126), such as one or more dialogue trees, agent information, and/or information from which agent information may be generated (e.g., background information or historical information). Additional examples are discussed below with respect to game agent data store 204 of FIG. 2.

While cloud service 102 is illustrated as including game service 114 and game agent data store 116, it will be appreciated that, in other examples, at least a part of such aspects may be provided by another computing device (not pictured) or may be performed local to a user's computing device, as may be the case when a virtual environment is an offline game. Further, while system 100 is illustrated as an example in which ML model processing is performed by cloud service 102 and computer-controlled agent behavior is managed by player device 106, it will be appreciated that any of a variety of other paradigms may be used. For example, ML model processing and computer-controlled agent management may both be performed locally by player device 106 or remotely by cloud service 102. As another example, a combination of local and remote processing may be used, as may be the case when one computer-controlled agent is player-specific (e.g., for a player of player device 106), while another computer-controlled agent is more generally available (e.g., for a group of players associated with game service 114).

FIG. 2 illustrates an overview of an example conceptual diagram 200 for generating machine learning-based dialogue according to aspects described herein. Diagram 200 includes user device 202, game agent data store 204, generative machine learning (ML) model 206, non-player character (NPC) agent 208, game development application 210, and agent information 212.

As illustrated, agent information 212, which includes offline information data source 214, properties/attributes/constraints 216, goals and paths 218, and contextual state/memory 220, one or more of which may form agent information that is processed by generative machine learning model 206 to generate model output according to aspects described herein. As discussed above, a developer may define and/or change elements 214, 216, 218, and/or 220 of agent information 212. Model output generated by generative ML model 206 (e.g., which may include a set of candidate interactions) may be evaluated by a developer using game development application 210 (aspects of which may be similar to game development application 120 discussed above with respect to FIG. 1).

Accordingly, selected candidate interactions may be used to generate a dialogue tree comprising one or more nodes (e.g., each of which may store at least a part of the model output from generative ML model 206) according to aspects described herein, which may be stored as dialogue trees 222 in game agent data store 204. Aspects of game agent data store 204 may be similar to game agent data store 116 and are therefore not necessarily redescribed in detail. While agent information 212 is illustrated as separate from game agent data store 204, it will be appreciated that, in other examples, such aspects may be stored together.

NPC agent 208 and user device 202 are thus able to interact based on dialogue trees 222 of game agent data store 204, such that a user of user device 202 perceives the resulting behavior of NPC agent 208 within a virtual environment.

Feedback/updates associated with NPC agent 208 may be obtained. In examples, the feedback received may be implicit and/or explicit. As noted above, implicit user feedback may be feedback data that is generated based upon user interactions with the game (e.g., as may be generated by a feedback collection engine, such as feedback collection engine 130 in FIG. 1). Thus, the received feedback may further affect the behavior of NPC agent 208 as a result to changes to agent information 212 (and, in some examples, alternatively or additionally to generative ML model 206). In examples, the feedback may be stored in a training data store, such as training data store 118 in FIG. 1.

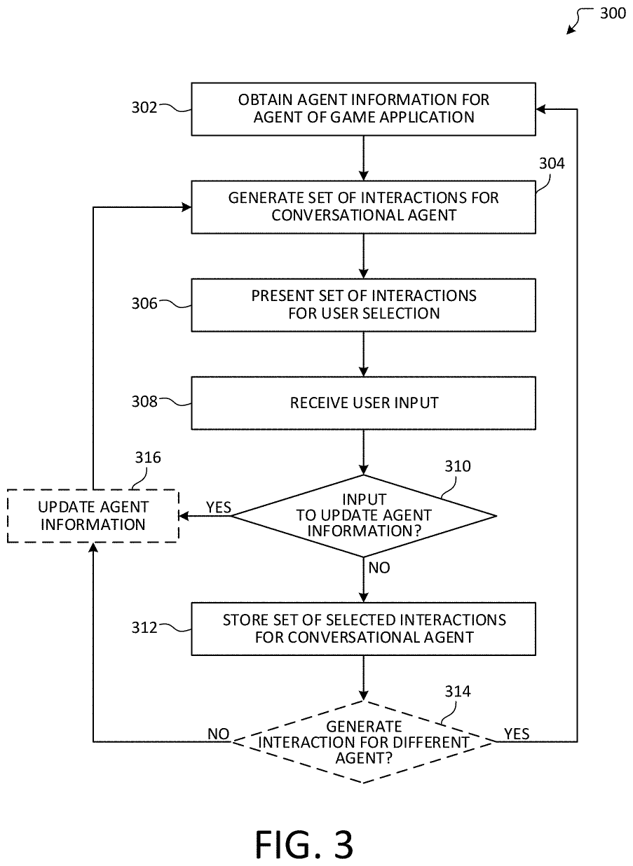

FIG. 3 illustrates an overview of an example method 300 for generating dialogue for a virtual environment using a machine learning-based dialogue authoring environment according to aspects described herein. In examples, aspects of method 300 may be performed by a game development application of a developer device, such as game development application 120 of developer device 104 discussed above with respect to FIG. 1. It will be appreciated that similar aspects may be performed by player device or by any of a variety of other devices, as may be the case when a player authors certain aspects of a virtual environment, among other examples.

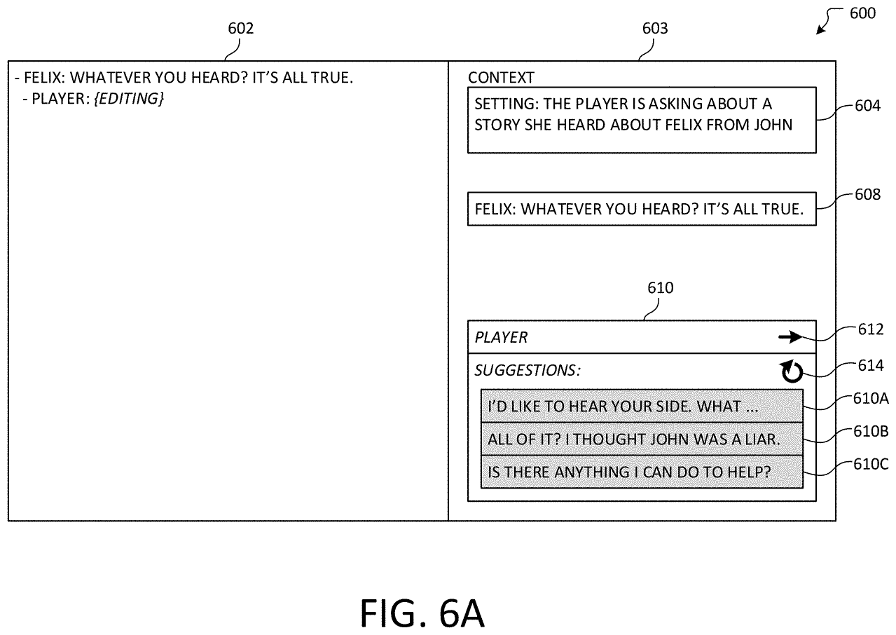

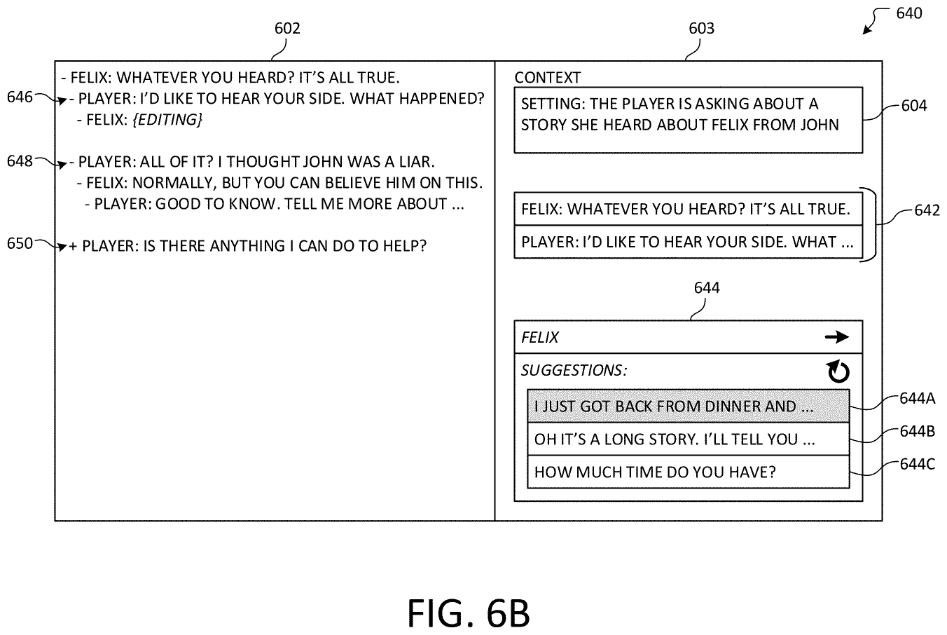

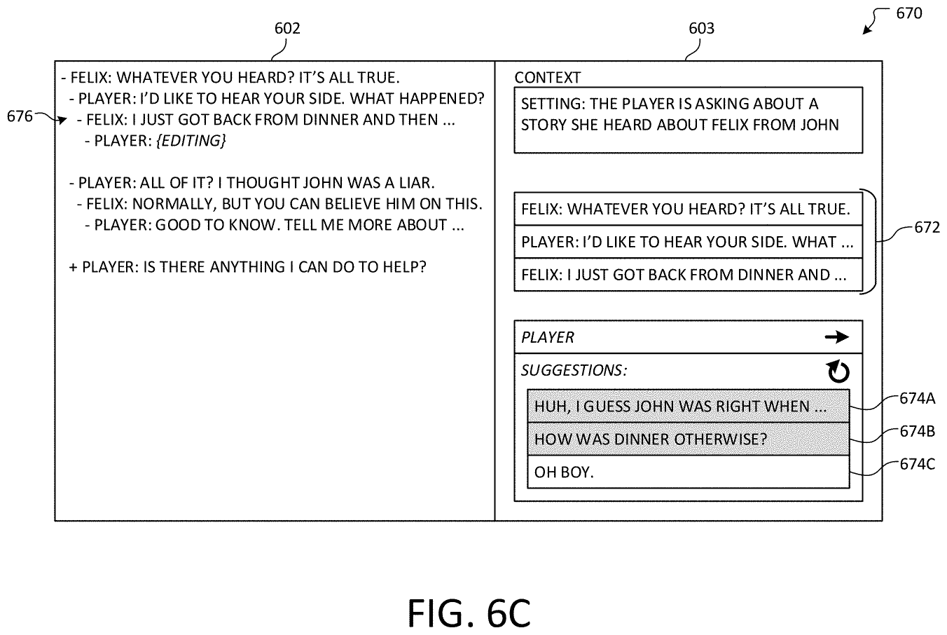

Method 300 begins at operation 302, where agent information is obtained for a computer-controlled agent of a game application or, in other examples, of any of a variety of other virtual environments. The agent information may include background information associated with a virtual environment and/or preexisting agent information (e.g., as may be associated with an agent template and/or another preexisting computer-controlled agent), as may be obtained from a game agent data store, such as game agent data store 116 in FIG. 1. In other examples, operation 302 may comprise requesting at least a part of the agent information from a user (e.g., using a graphical user interface of a game development application, such as game development application 120). Example user interface aspects are discussed below with respect to FIGS. 6A-6C. In some examples, at least a part of the agent information may be generated (e.g., by a prompt generator, such as prompt generator 122) based on feedback obtained from one or more user devices (e.g., as may be stored by a training data store, such as training data store 118). Thus, it will be appreciated that agent information may be obtained from any of a variety of sources.

Flow progresses to operation 304, where a set of candidate interactions is generated for a computer-controlled agent according to the agent information that was obtained at operation 302. Aspects of operation 304 may be performed by a model manager, such as model manager 124 in FIG. 1. In examples, operation 304 comprises providing an indication of at least a part of the agent information that was obtained at operation 302 to a machine learning service, such as machine learning service 110 of cloud service 102 in FIG. 1. The machine learning service may provide model output in response. In other examples, the agent information may be processed using an ML model locally, thereby obtaining model output from the local ML model. In some examples, operation 304 comprises selecting an ML model from a set of ML models, such that the selected model is thus used to generate model output accordingly.

As noted above, the set of candidate interactions may be generated based on a number of highly ranked instances of model output that are generated by an ML model or, as another example, may be generated to provide candidate interactions having varying tones, moods, and/or goals, among other examples. For example, the model manager may alter the agent information that is provided to the machine learning services to obtain a varying set of candidate interactions therefrom. Any of a variety of other “sampling” techniques may be used in other examples, aspects of which may be user-configurable (e.g., to specify the degree to which or in what way the candidate interactions vary). It will therefore be appreciated that any of a variety of techniques may be used to obtain model output based on agent information according to aspects of the present disclosure.

At operation 306, the set of candidate interactions are presented for user selection. In examples, operation 306 comprises displaying natural language output associated with each of the candidate interactions. In other examples, an interaction preview may be provided, where a computer-controlled agent expresses the candidate interaction within the virtual environment (e.g., including performing one or more associated animations or executing associated programmatic output). Thus, it will be appreciated that any of a variety of techniques may be used to present the set of candidate interactions according to aspects described herein.

Moving to operation 308, user input is received. In examples, the user input includes a selection of one or more candidate interactions that were presented at operation 306. In another example, the user input may include an indication to update agent information from which the set of candidate interactions was generated. For example, the user may decide to change the agent information when the set of candidate interactions differ from what the user envisioned. As another example the user may change the agent information to cause the resulting dialogue to follow a different path/storyline. Thus, it will be appreciated that agent information may be changed for any of a variety of reasons. In examples, feedback data may be generated, which may include implicit data (e.g., associated with a user selection, or lack thereof, of a candidate interaction) and/or explicit data (e.g., an explicit indication from a developer that a candidate is not relevant).

At determination 310, it is determined whether the user input is input to update agent information associated with the computer-controlled agent. If it is determined that the input is to update agent information, flow branches “YES” to operation 316, where agent information is updated. For example, operation 316 may comprise receiving additional user input that includes one or more changes to the agent information (e.g., via a user interface of the game development application). Accordingly, flow returns to operation 304, where a subsequent set of candidate interactions is generated based on the updated agent information.

Returning to determination 310, if it is instead determined that the input is not to update agent information, flow branches “NO” to operation 312, where the set of selected interactions is stored for a computer-controlled agent. The set of interactions may be stored in a dialogue tree, where each candidate interaction has an associated node. As discussed above, each node may include any of a variety of model output, including, but not limited to, natural language output, programmatic output, and/or an indication of a mood associated with the natural language output, among other examples. Each of the nodes generated at operation 312 may be a child node from the same parent node, as may be the case when the set of candidate interactions each represent a potential reaction to a dialogue turn represented by the parent node. The interactions may be stored in a game agent data store, such as game agent data store 116 or 204 in FIGS. 1 and 2, respectively.

Flow progresses to determination 314, where it is determined whether to generate an interaction for a different agent. For example, method 300 may be used to generate a multiparty dialogue, such that determination 314 may determine to next generate one or more interactions for another party of the dialogue. In another example, method 300 may be used to generate a single party dialogue (e.g., a monologue or a diary entry), such that determination 314 may determine not to change the agent for which dialogue is being generated. Determination 314 may be made based on user input indicating whether to change the party for which dialogue is being generated or, as another example, the determination may be made automatically (e.g., based on the content of the one or more interactions that were selected at operation 308 and/or based on whose dialogue turn is next in the dialogue tree). Determination 314 is illustrated using a dashed box to indicate that, in some examples, method 300 may terminate at 312.

If it is determined not to generate an interaction for a different party of the dialogue, flow branches “NO,” at which point it may arrive at operation 316 to update the agent information as discussed above. Operation 316 is illustrated using a dashed box to indicate that, in some examples, operation 316 may be omitted, such that flow progresses from determination 314 to operation 304.

However, if it is instead determined to generate an interaction for a different party of the dialogue, flow branches “YES” and returns to operation 302, such that agent information may be obtained for the other party. In examples, at least a part of the agent information obtained at operation 302 is similar to that which was used in a previous iteration of operation 302. Thus, subsequent iterations of operation 302 may comprise receiving user input associated with agent information, obtaining previously used agent information, and/or using agent information that is at least partially the same or similar to previously used agent information, among other examples. Method 300 may loop between operations 302, 304, 306, 308, 310, 312, 314, and 316 to generate dialogue for any number of computer-controlled agents and/or players, until it eventually terminates at operation 312.

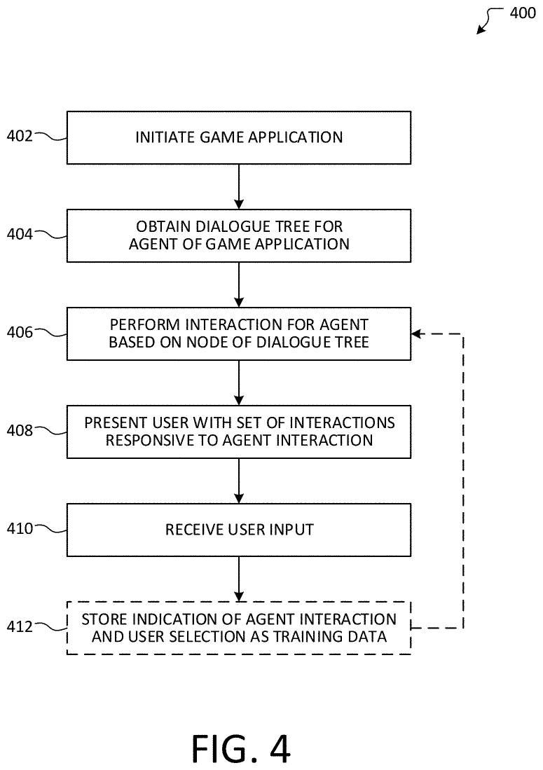

FIG. 4 illustrates an overview of an example method 400 for managing interactions between an agent and a user within a virtual environment based on machine learning-based dialogue according to aspects described herein. In examples, aspects of method 400 are performed by a player device, such as player device 106 or user device 202 discussed above with respect to FIGS. 1 and 2, respectively.

As illustrated, method 400 begins at operation 402, where a game application is initiated. For example, the game application may be game application 126 discussed above with respect to FIG. 1. As noted above, processing associated with the game application may be performed locally and/or may be performed remotely by a cloud service (e.g., game service 114 of cloud service 102). As another example, aspects of method 400 may be performed by an agent manager, such as agent manager 128 in FIG. 1.

Flow progresses to operation 404, where a dialogue tree is obtained for a computer-controlled agent of the game application. In examples, the dialogue tree is obtained from a game agent data store, such as game agent data store 116 or 204 in FIGS. 1 and 2, respectively. In some instances, the dialogue tree may be distributed as part of a game application (e.g., game application 126). Thus, it will be appreciated that a dialogue tree may be accessed from any of a variety of other data sources.

At operation 406, an interaction is performed for a computer-controlled agent based on a node of the dialogue tree. For example, a root node (e.g., a node having only one or more children nodes) or a node associated with a condition of the virtual environment may be identified, among other examples, such that natural language output may be presented to the user (e.g., as audio and/or textual output). As another example, associated programmatic output may be executed or an animation associated with an indicated mood may be performed, among other examples. In examples, operation 406 comprises processing the dialogue tree node to populate one or more placeholders with player-specific, device-specific, and/or virtual environment-specific information.

Moving to operation 408, a set of interactions is presented to the user that are responsive to the agent interaction that was performed at operation 406. For example, the set of interactions may be determined based on child nodes that are associated with the node from which the interaction was generated at operation 406. In examples, the set of candidate interactions may be sorted based on the likelihood that a user will select a given candidate interaction (e.g., as may be indicated by a dialogue tree node, determined based on feedback data for a population of users, based on the user's historical play style, and/or estimated by an ML model).

At operation 410, user input is received, which includes a selection of an interaction that was presented at operation 408. For example, the user input may include a mouse or touch actuation of a user interface element associated with a given interaction that was presented at operation 408, an actuation of a physical control associated with the given interaction, and/or voice input associated with the given interaction, among other examples.

While method 400 is illustrated as an example in which the computer-controlled agent provides an initial interaction (e.g., absent direct user input to engage with the computer-controlled agent), it will be appreciated that similar aspects may be used in instances where the computer-controlled agent is engaged in response to input received from a user. For example, a set of interactions may first be presented to a user (e.g., similar to operations 408 and 410), after which an associated interaction for a computer-controlled agent may be determined based on one or more child nodes associated with the dialogue tree node that was selected by the user. It will be appreciated that, in other examples, user selection of an interaction need not be so explicit and may instead be associated with movement of a user's player model or performance of any of a variety of tasks within a virtual environment.

Accordingly, at operation 412, an indication of the agent interaction and user selection may be stored as training data. Aspects of operation 412 may be performed by a feedback collection engine, such as feedback collection engine 130 discussed above with respect to FIG. 1. One or more such indications may be used to finetune aspects of an ML model that is used for dialogue authoring according to aspects described herein or, as another example, may be used to change an associated dialogue tree accordingly. In examples, the training data is provided to a cloud service (e.g., cloud service 102), where it may be stored in a training data store (e.g., training data store 118). Operation 412 is illustrated using a dashed box to indicate that, in some examples, operation 412 may be omitted. For example, aspects of method 400 may be performed separately from feedback generation or feedback generation may be performed after multiple iterations of method 400.

A dashed arrow is illustrated from operation 412 to operation 406 to indicate that, in some examples, method 400 may loop between operations 406, 408, and 410, as may be the case when a user engages in repeated interactions with a computer-controlled agent. It will be appreciated that, in some instances, operation 406 or operations 408/410 may be omitted, as may be the case when sequential dialogue tree nodes are associated with the same party rather than an alternating party. Method 400 may eventually terminate at operation 410 or operation 412.

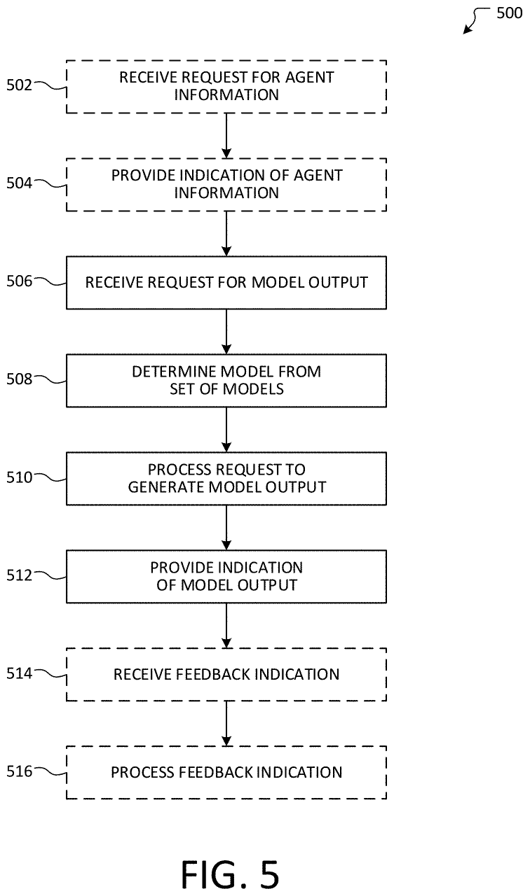

FIG. 5 illustrates an overview of an example method 500 for managing an agent for a virtual environment at a cloud service according to aspects described herein. For example, aspects of method 500 may be performed by cloud service 102 discussed above with respect to FIG. 1, which may be processing requests from a game development application (e.g., game development application 120) to provide a set of candidate interactions based on associated model output.

As illustrated, method 500 begins at operation 502, where a request for agent information is received. In examples, the request comprises an indication of a virtual environment and/or a computer-controlled agent for which the agent information is requested. Accordingly, at operation 504, an indication of the requested agent information is provided. The request may be received as a result of a device performing aspects of operation 302 discussed above with respect to method 300 in FIG. 3.

In examples, operation 504 includes generating the agent information from an agent template or from preexisting agent information, as may be the case when a computer-controlled agent from another virtual environment is used or when the agent information is supplemented with player-specific information (e.g., as may be received as part of the request or as may be obtained from a game service, such as game service 114 in FIG. 1). Thus, it will be appreciated that agent information may be obtained from any of a variety of sources and/or processed by any of a variety of computing devices (e.g. at cloud service 102, developer device 104, and/or player device 106) according to aspects described herein.

Operations 502 and 504 are illustrated using dashed boxes to indicate that, in some examples, they may be omitted such that method 500 starts at operation 506. For example, agent information may instead be locally defined by a developer, distributed with a game application, and/or may be obtained (e.g., by the game application) from any of a variety of other sources.

At operation 506, a request for model output is received. For example, the request may be received from a model manager, such as model manager 124 discussed above with respect to FIG. 1. In examples, the request is received as a result of a user computing device (e.g., developer device 104 in FIG. 1) performing aspects of operation 304 discussed above with respect to method 300 of FIG. 3, respectively. The request may include an indication of a user interaction and/or agent information for which model output is to be generated.

Accordingly, at operation 508, a model with which to generate the requested model output is determined from a set of models. In examples, the model is determined based on characteristics of a user or user account and/or based on characteristics of a user device, among other examples. As another example, the model may be determined based on a virtual environment associated with the received request, or the request may comprise an indication of a model with which to generate the model output, among other examples.

Flow progresses to operation 510, where the request is processed to generate model output accordingly. For example, the request may be processed by a machine learning service using the model that was determined at operation 508, such as machine learning service 110 of cloud service 102. As noted above, the generated model output may include natural language output, programmatic output, and/or any of a variety of other output types.

At operation 512, an indication of the generated model output is provided in response to the request that was received at operation 506. In examples, method 500 terminates at operation 512. In other examples, method 500 progresses to operation 514, where a feedback indication is received. For example, the indication may be received as a result of a user device performing aspects of operation 308 of method 300 or operation 412 of method 400.

In instances where a feedback indication is received, the feedback indication is processed at operation 516, for example to store the feedback indication in a training data store (e.g., training data store 118 in FIG. 1), to update a dialogue tree (e.g., as may be stored by a game agent data store such as game agent data store 116 or game agent data store 204 in FIG. 2), and/or to retrain or fine tune a model (e.g., as may be stored by a model repository, such as model repository 112). Method 500 may then terminate at operation 516.

It will be appreciated that, while aspects of method 300, 400, and 500 are described in the context of a user device or a cloud service, such aspects may be performed by any of a variety of devices. For example, aspects of method 300, 400, and 500 may be performed by the same computing device, as may be the case when a user acts as both a developer and a player and, further, the computer-controlled agent is managed locally.

FIGS. 6A-6C illustrate overviews of an example user interface with which dialogue may be authored according to aspects described herein. The illustrated aspects may be used by a game development application (e.g., game development application 120 in FIG. 1) to facilitate creation of a dialogue tree associated with one or more players and/or computer-controlled agents.

With reference to FIG. 6A, view 600 includes dialogue tree view 602 and editor pane 603. Dialogue tree view 602 enables a user to view at least a part of the dialogue tree. As illustrated, dialogue tree view 602 represents the hierarchical nature of a dialogue tree using indentations, where child nodes of the dialogue tree are depicted using increasing levels of indentation. Dialogue tree view 602 currently includes a root node for a non-player character named Felix, which is represented using the natural language output that is associated therewith.

Editor pane 603 includes context prompt input 604, conversation view 608, and candidate interaction selector 610. Context prompt input 604 enables a user to change agent information from which candidate interactions are generated (e.g., as are displayed by candidate interaction selector 610). It will be appreciated the context prompt input 604 is provided as a simplified example and, in other examples, any number of additional or alternative user interface controls may be used.

Conversation view 608 provides a view of a subpart of the dialogue tree that includes nodes along the path that is currently being edited via editor pane 603. Thus, as compared to dialogue tree view 602, conversation view 608 may exclude one or more nodes that are associated with other branches of the dialogue tree.

Candidate interaction selector 610 presents a set of candidate interactions for user selection (e.g., as may be generated as a result of performing aspects of method 300 of FIG. 3 discussed above). Candidates 610A, 610B, and 610C are illustrated using a grey background to indicate that they have been selected. Accordingly, if a user actuates submit control 612, nodes would be generated for each of the selected candidates. In another example, the user may actuate regenerate control 614, such that a new set of candidate interactions may be generated and presented via candidate interaction selector 610 according to aspects described herein.

While example user interface (UI) and associated user experience (UX) aspects are described, it will be appreciated that any of a variety of other UI/UX aspects may be used in other examples. For example, a dialogue tree may be represented graphically (e.g., as a graph or flow chart). As another example, editor pane 603 may include fewer, additional, or alternative controls. For instance, editor pane 603 may enable a user to change an associated mood or animation, among other examples. Additionally, while the instant examples include three candidates, it will be appreciated that any number of candidates may be presented in other examples. For example, the number of candidates may vary according to user preference, whether the dialogue is just starting or is nearing its conclusion, and/or a level of confidence provided by the ML model, among other examples.

With reference now to FIG. 6B, dialogue tree view 602 of view 640 now includes additional dialogue associated with a variety of additional dialogue tree nodes. For instance, nodes 646, 648, and 650 each correspond to suggestion candidate 610A, 610B, and 610C, respectively. Editor pane 603 is currently providing candidate interactions associated with node 646, such that conversation view 642 depicts nodes associated with that branch accordingly. Further, nodes 646 and 648 are illustrated as having been expanded, while node 650 has been collapsed. Candidate interaction selector 644 now shows that candidate 644A has been selected, while candidates 644B and 644C have not been selected.

Turning to FIG. 6C, view 670 depicts that additional dialogue tree node 676 was generated as a result of the user selection discussed above with respect to FIG. 6B. Similarly, conversation view 672 has been updated to reflect the addition of the resulting dialogue tree node. Accordingly, additional candidate interactions are displayed, of which candidates 674A and 674B have been selected, while candidate 674C has not been selected.

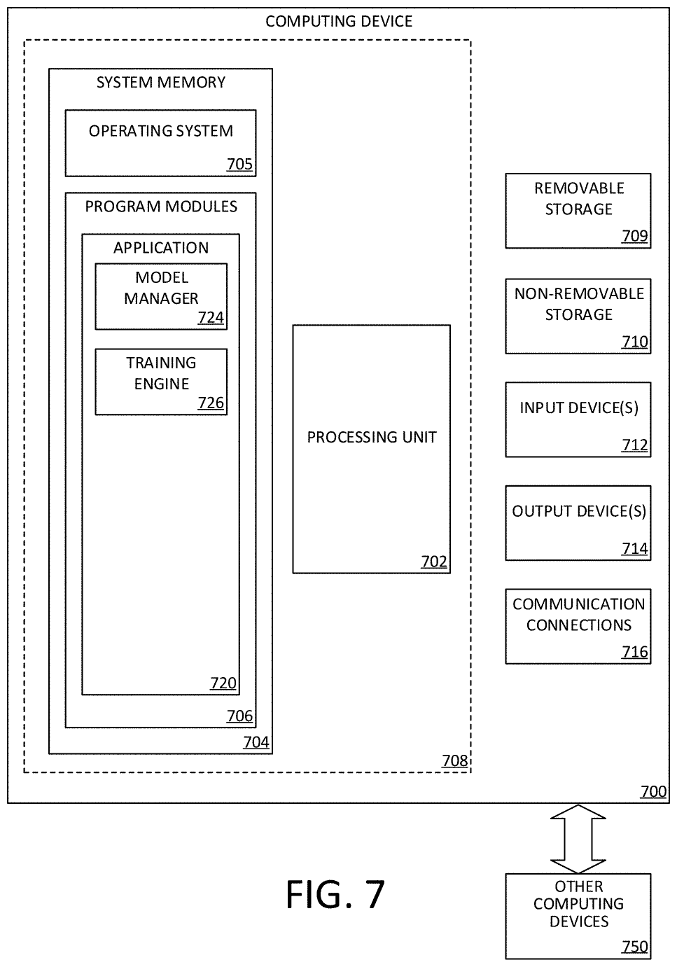

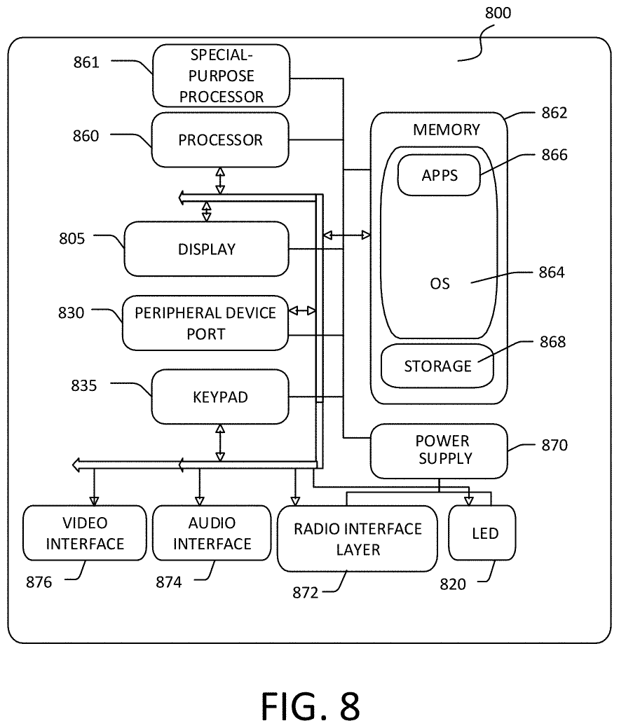

FIGS. 7 and 8 and the associated descriptions provide a discussion of a variety of operating environments in which aspects of the disclosure may be practiced. However, the devices and systems illustrated and discussed with respect to FIGS. 7 and 8 are for purposes of example and illustration and are not limiting of a vast number of computing device configurations that may be utilized for practicing aspects of the disclosure, described herein.

FIG. 7 is a block diagram illustrating physical components (e.g., hardware) of a computing device 700 with which aspects of the disclosure may be practiced. The computing device components described below may be suitable for the computing devices described above, including one or more devices associated with cloud service 102, as well as developer device 104 or player device 106 discussed above with respect to FIG. 1. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories.

The system memory 704 may include an operating system 705 and one or more program modules 706 suitable for running software application 720, such as one or more components supported by the systems described herein. As examples, system memory 704 may store model manager 724 and training engine 726. The operating system 705, for example, may be suitable for controlling the operation of the computing device 700.

Furthermore, embodiments of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., application 720) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIG. 8 illustrates a system 800 that may, for example, be a mobile computing device, such as a mobile telephone, a smart phone, wearable computer (such as a smart watch), a tablet computer, a laptop computer, and the like, with which embodiments of the disclosure may be practiced. In one embodiment, the system 800 is implemented as a “smart phone” capable of running one or more applications (e.g., browser, e-mail, calendaring, contact managers, messaging clients, games, and media clients/players). In some aspects, the system 800 is integrated as a computing device, such as an integrated personal digital assistant (PDA) and wireless phone.

In a basic configuration, such a mobile computing device is a handheld computer having both input elements and output elements. The system 800 typically includes a display 805 and one or more input buttons that allow the user to enter information into the system 800. The display 805 may also function as an input device (e.g., a touch screen display).

If included, an optional side input element allows further user input. For example, the side input element may be a rotary switch, a button, or any other type of manual input element. In alternative aspects, system 800 may incorporate more or less input elements. For example, the display 805 may not be a touch screen in some embodiments. In another example, an optional keypad 835 may also be included, which may be a physical keypad or a “soft” keypad generated on the touch screen display.

In various embodiments, the output elements include the display 805 for showing a graphical user interface (GUI), a visual indicator (e.g., a light emitting diode 820), and/or an audio transducer 825 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 800 also includes a non-volatile storage area 868 within the memory 862. The non-volatile storage area 868 may be used to store persistent information that should not be lost if the system 800 is powered down. The application programs 866 may use and store information in the non-volatile storage area 868, such as e-mail or other messages used by an e-mail application, and the like. A synchronization application (not shown) also resides on the system 800 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the system 800 described herein.

The system 800 has a power supply 870, which may be implemented as one or more batteries. The power supply 870 might further include an external power source, such as an AC adapter or a powered docking cradle that supplements or recharges the batteries.

The system 800 may also include a radio interface layer 872 that performs the function of transmitting and receiving radio frequency communications. The radio interface layer 872 facilitates wireless connectivity between the system 800 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via the audio transducer 825. In the illustrated embodiment, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with embodiments of the present disclosure, the microphone may also serve as an audio sensor to facilitate control of notifications, as will be described below. The system 800 may further include a video interface 876 that enables an operation of an on-board camera 830 to record still images, video stream, and the like.

It will be appreciated that system 800 may have additional features or functionality. For example, system 800 may also include additional data storage devices (removable and/or non-removable) such as, magnetic disks, optical disks, or tape. Such additional storage is illustrated in FIG. 8 by the non-volatile storage area 868.

Data/information generated or captured and stored via the system 800 may be stored locally, as described above, or the data may be stored on any number of storage media that may be accessed by the device via the radio interface layer 872 or via a wired connection between the system 800 and a separate computing device associated with the system 800, for example, a server computer in a distributed computing network, such as the Internet. As should be appreciated, such data/information may be accessed via the radio interface layer 872 or via a distributed computing network. Similarly, such data/information may be readily transferred between computing devices for storage and use according to any of a variety of data/information transfer and storage means, including electronic mail and collaborative data/information sharing systems.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

As will be understood from the foregoing disclosure, one aspect of the technology relates to a system comprising: at least one processor; and memory storing instructions that, when executed by the at least one processor, cause the system to perform a set of operations. The set of operations comprises: obtaining agent information for a computer-controlled agent of a virtual environment; generating, based on the agent information, a set of candidate interactions for the computer-controlled agent that includes model output associated with a multimodal machine learning model; presenting the set of candidate interactions for user selection; receiving a selection of one or more candidate interactions; and generating, for each selected candidate interaction, a node in a dialogue tree comprising natural language output for the selected candidate interaction. In an example, the computer-controlled agent is a first computer-controlled agent; the agent information is a first instance of agent information; the set of candidate interactions is a first set of candidate interactions; the generated nodes is a set of generated nodes for the first computer-controlled agent; and the set of operations further comprises: obtaining a second instance of agent information for a second computer-controlled agent of the virtual environment; generating, based on the second instance of agent information, a second set of candidate interactions for the second computer-controlled agent that includes model output associated with the multimodal machine learning model; presenting the second set of candidate interactions for user selection; receiving a second selection of one or more candidate interactions; and generating, for each selected candidate interaction for the second computer-controlled agent, a node in the dialogue tree comprising natural language output for the selected candidate interaction, wherein the generated node is associated with a node of the generated set of nodes for the first computer-controlled agent. In another example, the second instance of agent information includes an indication of a selected candidate interaction for the first computer-controlled agent. In a further example, the agent information comprises at least one of: background information associated with the virtual environment; historical information associated with the user; or virtual environment state information for the virtual environment. In yet another example, each generated node further comprises at least one of programmatic output of the model output or an associated emotion for the natural language output. In a further still example, the set of candidate interactions includes a first candidate interaction having a first mood and a second candidate interaction having a second mood that is different from the first mood. In another example, generating the set of candidate interactions comprises: providing, to a machine learning service, an indication of the agent information; and receiving, from the machine learning service, the model output.

In another aspect, the technology relates to a method. The method comprises: generating, based on a first instance of agent information, a first set of candidate interactions for a first computer-controlled agent; presenting the first set of candidate interactions for user selection; receiving a first selection of one or more of the first set of candidate interactions; generating, for each first selected candidate interaction, a node in a dialogue tree for the first computer-controlled agent; generating, based on a second instance of agent information, a second set of candidate interactions for a second computer-controlled agent; presenting the second set of candidate interactions for user selection; receiving a second selection of one or more of the second set of candidate interactions; generating, for each second selected candidate interaction, a node in the dialogue tree for the second computer-controlled agent, wherein the generated node is a child node of a node for the first computer-controlled agent; and storing the dialogue tree in a game agent data store for the virtual environment. In an example, the second instance of agent information is based on the first instance of agent information and includes an indication of a first selected candidate interaction for the first computer-controlled agent. In another example, the agent information comprises at least one of: background information associated with the virtual environment; historical information associated with the user; or virtual environment state information for the virtual environment. In a further example, generating the first set of candidate interactions comprises: providing, to a machine learning service, an indication of the first instance of agent information; and receiving, from the machine learning service, model output comprising the first set of candidate interactions. In yet another example, each generated node for the first computer-controlled agent comprises one or more of: natural language output of the model output; programmatic output of the model output; an emotion associated with the natural language output; or an indication of an animation for the first computer-controlled agent associated with the natural language output. In a further still example, the first instance of agent information comprises at least one of: background information associated with the virtual environment; historical information associated with the user; or virtual environment state information for the virtual environment.

In a further aspect, the technology relates to a method. The method comprises: obtaining agent information for a computer-controlled agent of a virtual environment; generating, based on the agent information, a set of candidate interactions for the computer-controlled agent that includes model output associated with a multimodal machine learning model; presenting the set of candidate interactions for user selection; receiving a selection of one or more candidate interactions; generating, for each selected candidate interaction, a node in a dialogue tree comprising natural language output for the selected candidate interaction; and storing the dialogue tree in a game agent data store for the virtual environment. In an example, presenting the set of candidate interactions comprises displaying natural language output of a multimodal machine learning model for each candidate interaction of the generated set of candidate interactions. In another example, obtaining the agent information comprises receiving user input that indicates a context for the computer-controlled agent. In a further example, generating the set of candidate interactions comprises altering the agent information for a specific mood, thereby obtaining a candidate interaction associated with the specific mood. In yet another example, the set of candidate interactions includes a first candidate interaction having a first mood and a second candidate interaction having a second mood that is different from the first mood. In a further still example, each generated node further comprises at least one of programmatic output of the model output or an associated emotion for the natural language output of the node. In another example, generating the set of candidate interactions comprises: providing, to a machine learning service, an indication of the agent information; and receiving, from the machine learning service, the model output.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
obtaining agent information for a computer-controlled agent of a virtual environment;
generating, based on the agent information, a set of candidate interactions for the computer-controlled agent that includes model output associated with a multimodal machine learning model;
presenting the set of candidate interactions for user selection;
receiving a selection of one or more candidate interactions; and
generating, for each selected candidate interaction, a node in a dialogue tree comprising natural language output for the selected candidate interaction.

2. The system of claim 1, wherein:
the computer-controlled agent is a first computer-controlled agent;
the agent information is a first instance of agent information;
the set of candidate interactions is a first set of candidate interactions;
the generated nodes is a set of generated nodes for the first computer-controlled agent; and
the set of operations further comprises:
obtaining a second instance of agent information for a second computer-controlled agent of the virtual environment;
generating, based on the second instance of agent information, a second set of candidate interactions for the second computer-controlled agent that includes model output associated with the multimodal machine learning model;
presenting the second set of candidate interactions for user selection;
receiving a second selection of one or more candidate interactions; and
generating, for each selected candidate interaction for the second computer-controlled agent, a node in the dialogue tree comprising natural language output for the selected candidate interaction, wherein the generated node is associated with a node of the generated set of nodes for the first computer-controlled agent.

3. The system of claim 2, wherein the second instance of agent information includes an indication of a selected candidate interaction for the first computer-controlled agent.

4. The system of claim 1, wherein the agent information comprises at least one of:
background information associated with the virtual environment;
historical information associated with the user; or
virtual environment state information for the virtual environment.

5. The system of claim 1, wherein each generated node further comprises at least one of programmatic output of the model output or an associated emotion for the natural language output.

6. The system of claim 1, wherein the set of candidate interactions includes a first candidate interaction having a first mood and a second candidate interaction having a second mood that is different from the first mood.

7. The system of claim 1, wherein generating the set of candidate interactions comprises:
providing, to a machine learning service, an indication of the agent information; and
receiving, from the machine learning service, the model output.

8. A method, comprising:
generating, based on a first instance of agent information, a first set of candidate interactions for a first computer-controlled agent;
presenting the first set of candidate interactions for user selection;
receiving a first selection of one or more of the first set of candidate interactions;
generating, for each first selected candidate interaction, a node in a dialogue tree for the first computer-controlled agent;
generating, based on a second instance of agent information, a second set of candidate interactions for a second computer-controlled agent;
presenting the second set of candidate interactions for user selection;
receiving a second selection of one or more of the second set of candidate interactions;
generating, for each second selected candidate interaction, a node in the dialogue tree for the second computer-controlled agent, wherein the generated node is a child node of a node for the first computer-controlled agent; and
storing the dialogue tree in a game agent data store for the virtual environment.

9. The method of claim 8, wherein the second instance of agent information is based on the first instance of agent information and includes an indication of a first selected candidate interaction for the first computer-controlled agent.

10. The method of claim 8, wherein the agent information comprises at least one of:
background information associated with the virtual environment;
historical information associated with the user; or
virtual environment state information for the virtual environment.

11. The method of claim 8, wherein generating the first set of candidate interactions comprises:
providing, to a machine learning service, an indication of the first instance of agent information; and
receiving, from the machine learning service, model output comprising the first set of candidate interactions.

12. The method of claim 11, wherein each generated node for the first computer-controlled agent comprises one or more of:
natural language output of the model output;
programmatic output of the model output;
an emotion associated with the natural language output; or
an indication of an animation for the first computer-controlled agent associated with the natural language output.

13. The method of claim 8, wherein the first instance of agent information comprises at least one of:
background information associated with the virtual environment;
historical information associated with the user; or
virtual environment state information for the virtual environment.

14. A method, comprising:
obtaining agent information for a computer-controlled agent of a virtual environment;
generating, based on the agent information, a set of candidate interactions for the computer-controlled agent that includes model output associated with a multimodal machine learning model;
presenting the set of candidate interactions for user selection;
receiving a selection of one or more candidate interactions;
generating, for each selected candidate interaction, a node in a dialogue tree comprising natural language output for the selected candidate interaction; and
storing the dialogue tree in a game agent data store for the virtual environment.

15. The method of claim 14, wherein presenting the set of candidate interactions comprises displaying natural language output of a multimodal machine learning model for each candidate interaction of the generated set of candidate interactions.

16. The method of claim 14, wherein obtaining the agent information comprises receiving user input that indicates a context for the computer-controlled agent.

17. The method of claim 14, wherein generating the set of candidate interactions comprises altering the agent information for a specific mood, thereby obtaining a candidate interaction associated with the specific mood.

18. The method of claim 17, wherein the set of candidate interactions includes a first candidate interaction having a first mood and a second candidate interaction having a second mood that is different from the first mood.

19. The method of claim 14, wherein each generated node further comprises at least one of programmatic output of the model output or an associated emotion for the natural language output of the node.

20. The method of claim 14, wherein generating the set of candidate interactions comprises:
providing, to a machine learning service, an indication of the agent information; and
receiving, from the machine learning service, the model output.
